(19) United States
(12) Patent Application Publication
(10) Pub. No.: US 2024/0097197 A1
(43) Pub. Date: Mar. 21, 2024

(54) NON-AQUEOUS RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Kazutaka YOSHIKAWA, Hamamatsu-shi (JP); Shotaro DEGUCHI, Toyohashi-shi (JP); Ryotaro SAKAI, Toyohashi-shi (JP); Shota UCHIYAMA, Kosai-shi (JP); Nobuaki KOIWA, Gamagori-shi (JP); Kentaro SUZUKI, Kariya-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/369,629

(22) Filed: Sep. 18, 2023

(30) Foreign Application Priority Data
Sep. 21, 2022 (JP) 2022-149720

(51) Int. Cl. H01M 10/0585; H01M 4/139; H01M 10/0525

(52) U.S. Cl. CPC H01M 10/0585; H01M 4/139; H01M 10/0525

(57) ABSTRACT

A non-aqueous rechargeable battery includes an electrode body in which a positive plate and a negative electrode plate are stacked in a stacking direction with a separator arranged in between. The positive electrode plate includes a positive electrode substrate, and a positive electrode mixture layer and an insulating layer arranged on each of two opposite surfaces of the positive electrode substrate. The positive electrode substrate includes a positive electrode uncoated portion. The electrode body includes a positive electrode current collector portion in which layers of the positive electrode uncoated portion are stacked in the stacking direction. A first insulating layer on a first surface of the positive electrode substrate, facing a center of the positive electrode current collector portion in the stacking direction, has a thickness that is greater than that of a second insulating layer on a second surface of the positive electrode substrate opposite to the first surface.

### BACKGROUND

### 1. Field

The following description relates to a non-aqueous rechargeable battery.

### 2. Description of Related Art

Electric vehicles and hybrid vehicles are powered by non-aqueous rechargeable batteries. A lithium-ion rechargeable battery, which is an example of a non-aqueous rechargeable battery, includes an electrode body formed by rolling a stack of a positive electrode plate, a negative electrode plate, and a separator arranged in between. The positive electrode plate includes a foil-like positive electrode substrate. A positive electrode mixture layer and an insulating layer are applied to the positive electrode substrate (for example, refer to Japanese Laid-Open Patent Publication No. 2021-089857). The positive electrode substrate includes a positive electrode uncoated portion where the positive electrode mixture layer and the insulating layer are not applied and the positive electrode substrate is exposed. In the electrode body, the positive electrode uncoated portion is rolled into a stack of layers that is press-bonded to form a positive electrode current collector for connection with an external terminal. The insulating layer is located between the positive electrode mixture layer and the positive electrode uncoated portion. The insulating layer insulates the positive electrode uncoated portion from the negative electrode plate so that short-circuiting does not occur therebetween.

### SUMMARY

It is preferred that the insulating layer be formed without narrowing the positive electrode mixture layer in order to maintain the battery performance qualities. Also, the insulating layer is formed so that the positive electrode uncoated portion has a narrow width to avoid enlargement of the battery. In this case, the width of the positive electrode uncoated portion may be insufficient for rolling the positive electrode uncoated portion into a stack of layers that is press-bonded. As a result, the joined foil may be defective. For example, the positive electrode substrate may become partially torn or the layers of the positive electrode uncoated portion may not be properly bonded together.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a non-aqueous rechargeable battery includes an electrode body in which a positive electrode plate and a negative electrode plate are stacked in a stacking direction with a separator arranged in between. The positive electrode plate includes a foil-like positive electrode substrate, and a positive electrode mixture layer and an insulating layer arranged on each of two opposite surfaces of the positive electrode substrate. The positive electrode substrate includes a positive electrode uncoated portion free from the positive electrode mixture layer and the insulating layer. The electrode body includes a positive electrode current collector portion in which layers of the positive electrode uncoated portion are stacked in the stacking direction. The insulating layer is located between the positive electrode mixture layer and the positive electrode uncoated portion. The insulating layer on a first surface of the positive electrode substrate defines a first insulating layer. The first surface faces a center of the positive electrode current collector portion in the stacking direction. The insulating layer on a second surface of the positive electrode substrate opposite to the first surface defines a second insulating layer. The first insulating layer has a thickness that is greater than that of the second insulating layer.

In the above non-aqueous rechargeable battery, the thickness of the first insulating layer may be in a range of 1.2 to 1.7 times the thickness of the second insulating layer.

In the above non-aqueous rechargeable battery, the thickness of the first insulating layer may be in a range of 5.0 μm to 20.0 μm. Further, the thickness of the second insulating layer may be in a range of 3.0 μm to 16.0 μm.

In the above non-aqueous rechargeable battery, the insulating layer may include a binder. Further, a mass ratio of the binder to a mass of the insulating layer may be in a range of 10 mass % to 30 mass %.

In the above non-aqueous rechargeable battery, the first insulating layer and the second insulating layer may each have a width in a range of 2.5 mm to 4.5 mm.

Other features and aspects will be apparent from the following detailed description, the drawings, and the claims.

### BRIEF DESCRIPTION OF THE DRAWINGS

FIG. 1 is a perspective view of a lithium-ion rechargeable battery.

FIG. 2 is a perspective view of an electrode body in an unrolled state.

FIG. 3 is a cross-sectional view taken along line of FIG. 2.

FIG. 4 is an enlarged cross-sectional view showing a main part of a positive electrode uncoated portion before forming a positive electrode current collector portion.

FIG. 5 is an enlarged cross-sectional view showing a main part of the positive electrode current collector portion.

FIG. 6 is an enlarged cross-sectional view showing a main part of the positive electrode uncoated portion forming the positive electrode current collector portion.

FIG. 7 is a flowchart illustrating a manufacturing process of the lithium-ion rechargeable battery.

FIG. 8 is a table showing parameters of Example and Comparative Examples.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

Lithium-Ion Rechargeable Battery

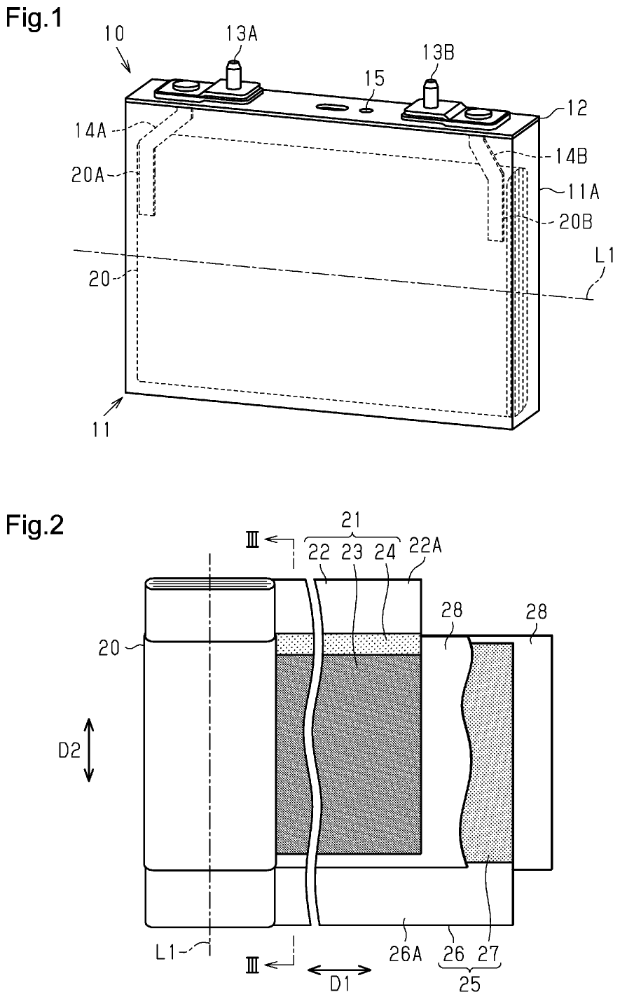

As shown in FIG. 1, a lithium-ion rechargeable battery 10, which is an example of a non-aqueous rechargeable battery, includes a case 11 and an electrode body 20. The case 11 includes an accommodation portion 11A and a lid 12. The accommodation portion 11A is box-shaped and has an open upper end. The accommodation portion 11A accommodates the electrode body 20 and a non-aqueous electrolyte. The lid 12 closes the opening of the accommodation portion 11A. The case 11 forms a sealed box-shaped battery container by attaching the lid 12 to the accommodation portion 11A. The case 11 is formed from a metal such as aluminum or an aluminum alloy.

An external terminal 13A of the positive electrode and an external terminal 13B of the negative electrode are arranged on the lid 12. A positive electrode current collector portion 20A, which is the positive end of the electrode body 20, is electrically connected by a positive electrode current collector member 14A to the positive electrode external terminal 13A. A negative electrode current collector portion 20B, which is the negative end of the electrode body 20, is electrically connected by a negative electrode current collector member 14B to the negative electrode external terminal 13B. Further, the lid 12 includes an inlet 15 for injection of the non-aqueous electrolyte. The external terminals 13A and 13B do not have to be shaped as shown in FIG. 1 and may have any shape.

Electrode Body

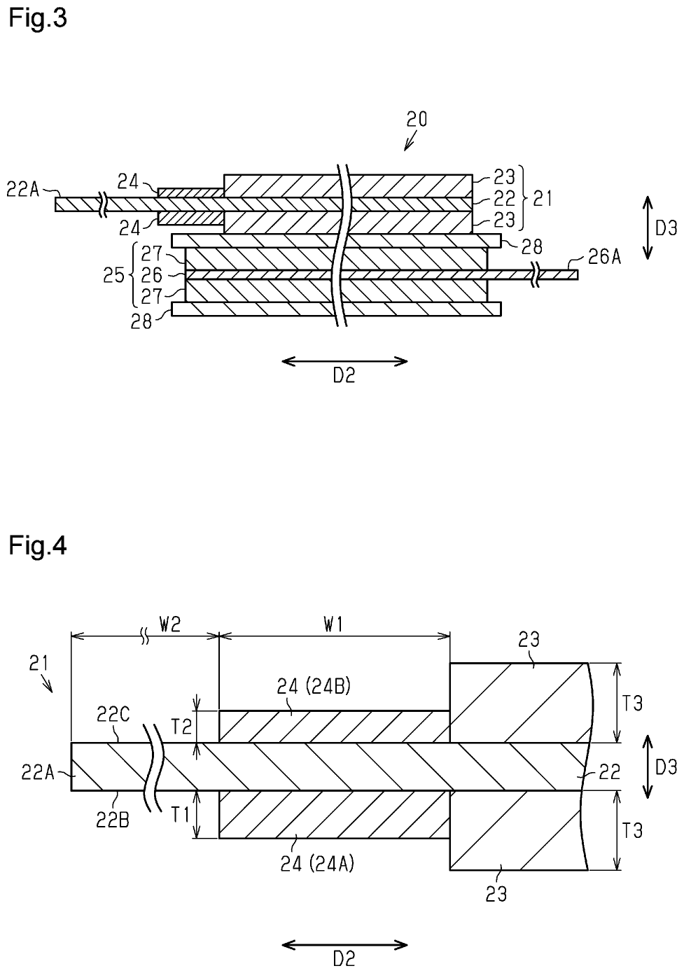

As shown in FIG. 2, the electrode body 20 is a flat rolled body formed by rolling a stack of strips of a positive electrode plate 21, a negative electrode plate 25, and separators 28. The positive electrode plate 21, the negative electrode plate 25, and the separators 28 are stacked so that their long sides are parallel to a longitudinal direction D1. The positive electrode plate 21, the separator 28, the negative electrode plate 25, and the separator 28 are arranged in this order in a stacking direction D3 (refer to FIG. 3) to form an unrolled stack. The electrode body 20 is structured by rolling the stack of the positive electrode plate 21 and the negative electrode plate 25 with the separators 28 held in between about a rolling axis L1 that extends in a widthwise direction D2 of the strips.

Positive Electrode Plate

As shown in FIG. 3, the positive electrode plate 21 includes a positive electrode substrate 22, a positive electrode mixture layer 23, and an insulating layer 24. The positive electrode substrate 22 is a strip of a foil. The positive electrode mixture layer 23 and the insulating layer 24 are applied to each of two opposite surfaces of the positive electrode substrate 22. One end of the positive electrode substrate 22 in the widthwise direction D2 includes a positive electrode uncoated portion 22A where the positive electrode mixture layer 23 and the insulating layer 24 are not formed and the positive electrode substrate 22 is exposed. The insulating layer 24 is located between the positive electrode uncoated portion 22A and the positive electrode mixture layer 23. The insulating layer 24 restricts short circuiting between the positive electrode uncoated portion 22A and the negative electrode plate 25 caused by foreign matter or the like.

The positive electrode substrate 22 is a foil of a metal such as aluminum or an alloy having aluminum as a main component. In the roll, the opposing parts in the positive electrode uncoated portion 22A of the positive electrode substrate 22 are stacked in the stacking direction D3 and press-bonded to form the positive electrode current collector portion 20A.

The positive electrode mixture layer 23 is formed by hardening a positive electrode mixture paste, which is in a liquid form. The positive electrode mixture paste includes a positive electrode active material, a positive electrode solvent, a positive electrode conductive material, and a positive electrode binder. The positive electrode mixture paste is dried and the positive electrode solvent is vaporized to form the positive electrode mixture layer 23. Thus, the positive electrode mixture layer 23 includes the positive electrode active material, the positive electrode conductive material, and the positive electrode binder.

The positive electrode active material is a lithium-containing composite metal oxide that allows for the storage and release of lithium ions, which serve as the charge carrier of the lithium-ion rechargeable battery 10. A lithium-containing composite metal oxide is an oxide containing lithium and a metal element other than lithium. The metal element other than lithium is, for example, one selected from a group consisting of nickel, cobalt, manganese, vanadium, magnesium, molybdenum, niobium, titanium, tungsten, aluminum, and iron contained as iron phosphate in the lithium-containing composite metal oxide.

The lithium-containing composite metal oxide may be, for example, lithium cobalt oxide (LiCoO₂), lithium nickel oxide (LiNiO₂), or lithium manganese oxide (LiMn₂O₄). Further, the lithium-containing composite metal oxide may be, for example, a three-element lithium-containing composite metal oxide (NCM) that contains nickel, cobalt, and manganese, that is, lithium nickel manganese cobalt oxide (LiNiCoMnO₂). Further, the lithium-containing composite metal oxide may be, for example, lithium iron phosphate (LiFePO₄).

The positive electrode solvent is an N-methyl-2-pyrrolidone (NMP) solvent, which is an example of an organic solvent. The positive electrode conductive material is, for example, carbon black such as acetylene black (AB) or ketjen black, carbon fibers such as carbon nanotubes (CNT) or carbon nanofibers, or graphite. The positive electrode binder is an example of a resin component included in the positive electrode mixture paste. The positive electrode binder is, for example, polyvinylidene fluoride (PVDF), polyvinyl alcohol (PVA), styrene-butadiene rubber (SBR), or the like.

The insulating layer 24 is formed by hardening an insulating paste, which is in a liquid form. The insulating paste includes an insulating layer inorganic component having an insulating property, an insulating layer binder, and an insulating layer solvent. The insulating paste is dried and the insulating layer solvent is vaporized to form the insulating layer 24. Thus, the insulating layer 24 includes the insulating layer inorganic component and the insulating layer binder.

The insulating layer inorganic component is at least one selected from a group consisting of boehmite powder, titania, and alumina. The insulating layer binder is a resin component that is soluble in the insulating layer solvent. For example, the insulating layer binder is at least one selected from a group consisting of PVDF, PVA, SBR, and acrylic. The solvent component is an organic solvent or water. An example of the organic solvent is an NMP solution.

A mass ratio of the insulating layer binder to a total mass of the insulating layer 24 is, for example, in a range of 10 mass % to 30 mass %. When the mass ratio of the insulating layer binder is 10 mass % or greater, the delamination strength is ensured between the insulating layer 24 and the positive electrode substrate 22. When the mass ratio of the insulating layer binder is 30 mass % or less, the insulating layer 24 avoids an excessive decrease in the mechanical strength due to a relative decrease in the mass ratio of the insulating layer inorganic component.

Negative Electrode Plate

The negative electrode plate 25 includes a negative electrode substrate 26 and a negative electrode mixture layer 27. The negative electrode substrate 26 is a strip of a foil. The negative electrode mixture layer 27 is applied to each of two opposite surfaces of the negative electrode substrate 26. One end of the negative electrode substrate 26 in the widthwise direction D2 at the side opposite the positive electrode uncoated portion 22A includes a negative electrode uncoated portion 26A where the negative electrode mixture layer 27 is not formed and the negative electrode substrate 26 is exposed.

The negative electrode substrate 26 is a foil of a metal such as copper or an alloy having copper as a main component. In the roll, the opposing parts in the negative electrode uncoated portion 26A are stacked in the stacking direction D3 and press-bonded to form the negative electrode current collector portion 20B.

The negative electrode mixture layer 27 is formed by hardening a negative electrode mixture paste, which is in a liquid form. The negative electrode mixture paste includes a negative electrode active material, a negative electrode solvent, a negative electrode viscosity increasing agent, and a negative electrode binder. The negative electrode mixture paste is dried and the negative electrode solvent is vaporized to form the negative electrode mixture layer 27. Thus, the negative electrode mixture layer 27 includes the negative electrode active material, the negative electrode viscosity increasing agent, and the negative electrode binder. The negative electrode mixture layer 27 may further include an additive such as a conductive agent.

The negative electrode active material allows for the storage and release of lithium ions. The negative electrode active material is, for example, a carbon material such as graphite, hard carbon, soft carbon, or carbon nanotubes. The negative electrode active material may be composite particles in which graphite particles are coated with an amorphous carbon layer.

An example of the negative electrode solvent is water. An example of the negative electrode viscosity increasing agent may be carboxymethyl cellulose (CMC). The negative electrode binder may use the same material as the positive electrode binder. An example of the negative electrode binder is SBR.

Separator

The separators 28 prevent contact between the positive electrode plate 21 and the negative electrode plate 25 in addition to holding the non-aqueous electrolyte between the positive electrode plate 21 and the negative electrode plate 25. Immersion of the electrode body 20 in the non-aqueous electrolyte results in the non-aqueous electrolyte permeating each separator 28 from the ends toward the center.

The separator 28 is a nonwoven fabric of polypropylene or the like. The separator 28 may be, for example, a porous polymer film, such as a porous polyethylene film, a porous polyolefin film, or a porous polyvinyl chloride film, an ion conductive polymer electrolyte film, or the like.

Non-Aqueous Electrolyte

The non-aqueous electrolyte is a composition containing a supporting electrolyte in a non-aqueous solvent. The non-aqueous solvent is one or two or more selected from, for example, a group consisting of propylene carbonate, ethylene carbonate, diethyl carbonate, dimethyl carbonate, and ethyl methyl carbonate. The supporting electrolyte is a lithium compound (lithium salt) of one or two or more selected from, for example, a group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

In the present embodiment, ethylene carbonate is used as the non-aqueous solvent. Lithium bis(oxalate)borate (LiBOB), which is a lithium salt, is added to the non-aqueous electrolyte as an additive. For example, LiBOB is added to the non-aqueous electrolyte so that the concentration of LiBOB in the non-aqueous electrolyte is in a range of 0.001 mol/L to 0.1 mol/L.

Structure of Positive Electrode Plate End

As shown in FIG. 4, the positive electrode substrate 22 includes a first surface 22B and a second surface 22C. The first surface 22B and the second surface 22C are two surfaces facing opposite directions, and the positive electrode mixture layer 23 and the insulating layer 24 are arranged on each of the two surfaces. The insulating layer 24 on the first surface 22B defines a first insulating layer 24A. The insulating layer 24 on the second surface 22C opposite to the first surface 22B defines a second insulating layer 24B. In the following description, when the first insulating layer 24A and the second insulating layer 24B are not being distinguished from each other, they are simply referred to as the insulating layer 24.

The first insulating layer 24A has a thickness T1 that is greater than thickness T2 of the second insulating layer 24B. In an example, thickness T1 of the first insulating layer 24A is set to be greater than thickness T2 of the second insulating layer 24B in a range in which thickness T1 of the first insulating layer 24A and thickness T2 of the second insulating layer 24B are between 3.0 μm and 20.0 μm, inclusive.

When thickness T1 of the first insulating layer 24A and thickness T2 of the second insulating layer 24B are set to 3.0 μm or greater, the mechanical strengths of the first insulating layer 24A and the second insulating layer 24B are improved. Thus, even if foreign matter is present between the insulating layer 24 and the negative electrode plate 25, the foreign matter will not penetrate the insulating layer 24 and cause short circuiting between the positive electrode uncoated portion 22A and the negative electrode plate 25. When thickness T1 of the first insulating layer 24A and thickness T2 of the second insulating layer 24B are set to 20.0 μm or less, the foil-joining property of the positive electrode uncoated portion 22A will be maintained. This avoids a situation in which the positive electrode uncoated portion 22A becomes difficult to bend due to increases in thickness T1 of the first insulating layer 24A and thickness T2 of the second insulating layer 24B.

Further, thickness T1 of the first insulating layer 24A and thickness T2 of the second insulating layer 24B are less than thickness T3 of the positive electrode mixture layer 23. Thus, the first insulating layer 24A and the second insulating layer 24B will not contact a press roll when adjusting thickness T3 of the positive electrode mixture layer 23 in a manufacturing process. Thickness T3 of the positive electrode mixture layer 23 is, for example, in a range of 20.0 μm to 25.0 μm.

The first insulating layer 24A and the second insulating layer 24B have the same width W1 in the widthwise direction D2. Width W1 of the insulating layer 24 corresponds to the distance from the boundary of the positive electrode mixture layer 23 and the insulating layer 24 to the end of the insulating layer 24 as viewed in a direction parallel to the stacking direction D3 from a viewpoint facing the positive electrode mixture layer 23 and the insulating layer 24.

Width W1 of the insulating layer 24 is, for example, in a range of 2.5 mm to 4.5 mm. When width W1 of the insulating layer 24 is within the above range, short circuiting is appropriately restricted between the positive electrode uncoated portion 22A and the negative electrode plate 25. Also, width W2 of the positive electrode uncoated portion 22A in the widthwise direction D2 will not become too small. Width W2 of the positive electrode uncoated portion 22A is, for example, in a range of 7.0 mm to 13.0 mm.

At the boundary of the positive electrode mixture layer 23 and the insulating layer 24, the insulating layer 24 may cover the end of the positive electrode mixture layer 23. Alternatively, the positive electrode mixture layer 23 may cover the end of the insulating layer 24. In such structures, width W1 of the insulating layer 24 may only be set in the above-described range as viewed in a direction parallel to the stacking direction D3 from a viewpoint facing the positive electrode mixture layer 23 and the insulating layer 24.

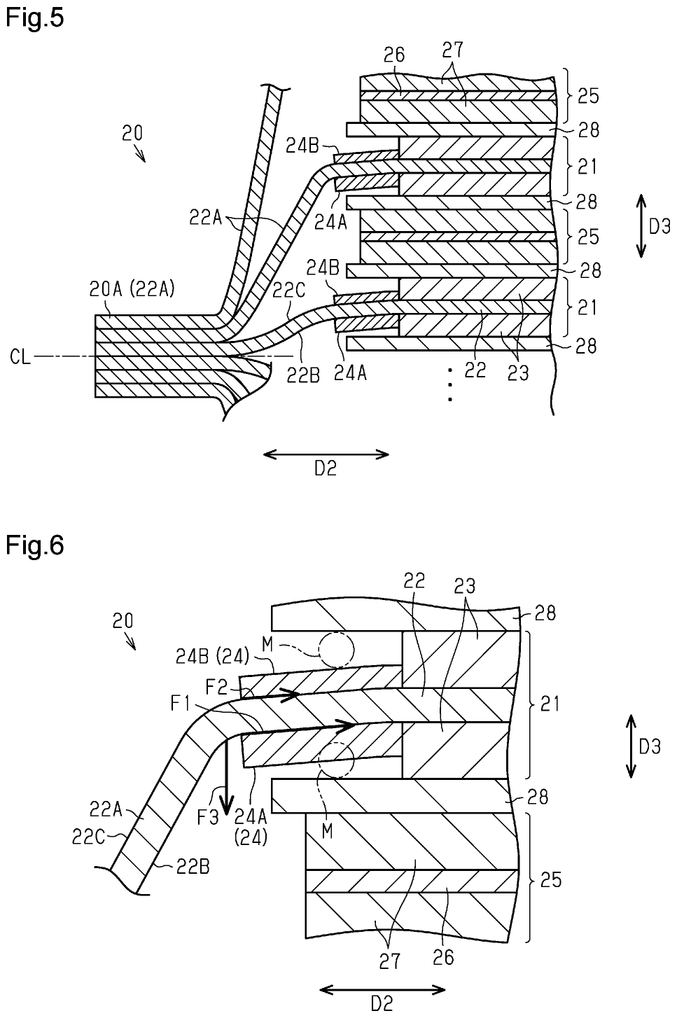

As shown in FIG. 5, the positive electrode current collector portion 20A of the electrode body 20 is formed by press-bonding the opposing parts in the rolled positive electrode uncoated portion 22A that are stacked in the stacking direction D3. The layers of the positive electrode uncoated portion 22A are bent toward the center of the positive electrode current collector portion 20A. In FIG. 5, the center of the positive electrode current collector portion 20A in the stacking direction D3 is indicated by the centerline CL.

In the electrode body 20, the first surface 22B of the positive electrode substrate 22 faces the center of the positive electrode current collector portion 20A in the stacking direction D3. The second surface 22C of the positive electrode substrate 22 faces the side opposite to the center of the positive electrode current collector portion 20A in the stacking direction D3. The first insulating layer 24A is located toward the center (centerline CL) of the positive electrode current collector portion 20A in the stacking direction D3 with respect to the positive electrode substrate 22. For example, in the roll of the electrode body 20, the first insulating layer 24A is located toward the rolling axis L1 of the electrode body 20 with respect to the positive electrode substrate 22. The second insulating layer 24B is located opposite to the first insulating layer 24A with respect to the positive electrode substrate 22.

### Operation of Present Embodiment

As shown in FIG. 6, when the insulating paste is dried to form the insulating layer 24 and the volume of the insulating paste is reduced, a contraction stress caused by the insulating layer binder acts on the positive electrode substrate 22. For example, when the first insulating layer 24A is formed on the first surface 22B of the positive electrode substrate 22, a first contraction stress F1 toward the positive electrode mixture layer 23 in the widthwise direction D2 is applied to the first surface 22B. When the second insulating layer 24B is formed on the second surface 22C of the positive electrode substrate 22, a second contraction stress F2 toward the positive electrode mixture layer 23 in the widthwise direction D2 is applied to the second surface 22C.

The intensity of the contraction stress has a positive correlation with the volume of the insulating layer 24. Since thickness T1 of the first insulating layer 24A is greater than thickness T2 of the second insulating layer 24B, the first contraction stress F1 applied to the first surface 22B is greater than the second contraction stress F2 applied to the second surface 22C. Accordingly, the difference in the first contraction stress F1 and the second contraction stress F2, or a resultant force F3, acts on the positive electrode substrate 22 to bend the positive electrode substrate 22 toward the center of the positive electrode current collector portion 20A in the stacking direction D3. This improves the foil-joining property of the positive electrode uncoated portion 22A when forming the positive electrode current collector portion 20A.

In an example, the preferred difference in contraction stress will be obtained between the first insulating layer 24A and the second insulating layer 24B when width W1 of the first insulating layer 24A and width W1 of the second insulating layer 24B are 2.5 mm or greater. Further, the resultant force F3 has an intensity that allows the positive electrode substrate 22 to be easily bent toward the center of the positive electrode current collector portion 20A. For example, the resultant force F3 may allow the positive electrode substrate 22 to be bent against the rigidity of the positive electrode substrate 22. Alternatively, the resultant force F3 may be such that the positive electrode substrate 22 cannot be bent because of the rigidity of the positive electrode substrate 22. In other words, the first insulating layer 24A and the second insulating layer 24B that differ in thickness may have a contraction stress difference that allows bending of the positive electrode substrate 22 when a force is applied or allows bending of the positive electrode substrate 22 without any force.

Preferably, thickness T1 of the first insulating layer 24A is, for example, in a range of 1.2 to 1.7 times thickness T2 of the second insulating layer 24B. When thickness T1 of the first insulating layer 24A is at least 1.2 times thickness T2 of the second insulating layer 24B, the contraction stress difference between the first insulating layer 24A and the second insulating layer 24B suitably acts on the positive electrode substrate 22. When thickness T1 of the first insulating layer 24A is greater than thickness T2 of the second insulating layer 24B by 1.7 times or less, the second insulating layer 24B will not become relatively too thin. This maintains the mechanical strength of the second insulating layer 24B.

Preferably, thickness T1 of the first insulating layer 24A is, for example, in a range of 5.0 μm to 20.0 μm. In this case, it is preferred that thickness T2 of the second insulating layer 24B be set in a range of 3.0 μm to 16.0 μm and that thickness T1 be in a range of 1.2 to 1.7 times thickness T2. When thickness T1 and thickness T2 are within the above ranges, the mechanical strength of the second insulating layer 24B is ensured. This also avoids decreases in the foil-joining property of the positive electrode uncoated portion 22A caused by an increase in thickness T1 of the first insulating layer 24A. Further, the contraction stress difference acting on the positive electrode substrate 22 has an effect of improving the foil-joining property of the positive electrode uncoated portion 22A.

The intensity of the contraction stress has a positive correlation with the mass ratio of the insulating layer binder to the total mass of the insulating layer 24. Thus, for example, when the mass ratio of the insulating layer binder to the total mass of the insulating layer 24 is 10 mass % or greater, the contraction stress difference between the first insulating layer 24A and the second insulating layer 24B suitably acts on the positive electrode substrate 22. The intensity of the contraction stress also depends on the type and molecular weight of the insulating layer binder.

Further, the distance from the first surface 22B of the positive electrode substrate 22, at a position where the first insulating layer 24A is arranged, to an adjacent negative electrode plate 25 and the separator 28 becomes less than the distance from the second surface 22C of the positive electrode substrate 22, at a position where the second insulating layer 24B is arranged, to an adjacent negative electrode plate 25 and the separator 28. Accordingly, if foreign matter M, indicated by the double-dashed line shown in FIG. 6, enters between the insulating layer 24 and the negative electrode plate 25 and the separator 28, the foreign matter M will apply a larger force to the first insulating layer 24A than the second insulating layer 24B.

In this respect, thickness T1 of the first insulating layer 24A is set to be greater than thickness T2 of the second insulating layer 24B. This increases the mechanical strength of the first insulating layer 24A and surely restricts short circuiting between the first surface 22B and the negative electrode plate 25.

Method for Manufacturing Lithium-Ion Rechargeable Battery

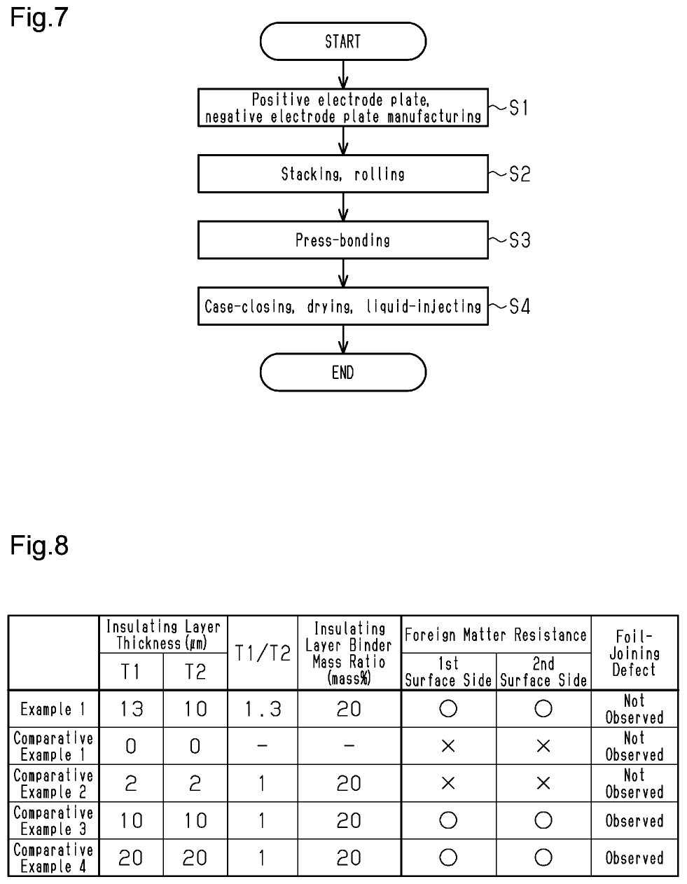

As shown in FIG. 7, a method for manufacturing the lithium-ion rechargeable battery 10 includes steps S1 to S4. Step S1 is a step of manufacturing the positive electrode plate 21 and the negative electrode plate 25. In the step of manufacturing the positive electrode plate 21, one strip of the positive electrode mixture paste and two strips of the insulating paste are simultaneously applied to each of the first surface 22B and the second surface 22C such that the positive electrode uncoated portion 22A is included at both ends of the positive electrode substrate 22 in the widthwise direction D2. In this case, the two strips of insulating paste are applied such that one of the two strips contacts one end of the positive electrode mixture paste in the widthwise direction D2, and the other strip contacts the other end of the positive electrode mixture paste. Then, the positive electrode mixture paste and the insulating paste are dried to form the positive electrode mixture layer 23 and the insulating layers 24. Next, the positive electrode mixture layer 23, formed on both surfaces of the positive electrode substrate 22, is pressed to adjust the thickness of the positive electrode mixture layer 23. Subsequently, the positive electrode substrate 22 is cut at the center in the widthwise direction D2. In this manner, two strips of the positive electrode plates 21 are manufactured at the same time through the above steps.

In the step of manufacturing the negative electrode plate 25, the negative electrode mixture paste is applied to the two surfaces of the negative electrode substrate 26 facing opposite directions such that the negative electrode uncoated portion 26A is included at both ends of the negative electrode substrate 26 in the widthwise direction D2. Then, negative electrode mixture paste is dried to form the negative electrode mixture layer 27. Next, the negative electrode mixture layer 27, formed on both surfaces of the negative electrode substrate 26, is pressed to adjust the thickness of the negative electrode mixture layer 27. Subsequently, the negative electrode substrate 26 is cut at the center in the widthwise direction D2. In this manner, two strips of the negative electrode plates 25 are manufactured at the same time through the above steps.

In step S2, the positive electrode plate 21, the negative electrode plate 25, and the separators 28 are stacked and rolled. Further, the roll is pressed and flattened. In step S3, the rolled positive electrode uncoated portion 22A is joined such that the opposing parts in the positive electrode uncoated portion 22A are stacked in the stacking direction D3. In this state, the joined positive electrode uncoated portion 22A is press-bonded to form the positive electrode current collector portion 20A. The press-bonding means is, for example, ultrasonic welding. Further, in step S3, the opposing parts in the negative electrode uncoated portion 26A are stacked in the stacking direction D3 through the same procedure as that for the positive electrode, and then the negative electrode uncoated portion 26A is press-bonded to form the negative electrode current collector portion 20B. These procedures manufacture the electrode body 20.

In step S4, the electrode body 20 is arranged in the case 11 and the case 11 is sealed. In this case, the positive electrode current collector portion 20A is connected via the positive electrode current collector member 14A to the positive electrode external terminal 13A. The negative electrode current collector portion 20B is connected via the negative electrode current collector member 14B to the negative electrode external terminal 13B. The upper end of the accommodation portion 11A is closed by the lid 12. Subsequently, the electrode body 20 is heated to remove moisture from the electrode body 20. Then, the non-aqueous electrolyte is injected into the case 11. In this manner, the lithium-ion rechargeable battery 10 is assembled.

### Advantages of the Embodiment

The above embodiment has the following advantages.

(1) When thickness T1 of the first insulating layer 24A is greater than thickness T2 of the second insulating layer 24B, the resultant force F3 acts on the positive electrode substrate 22 to bend the positive electrode substrate 22 toward the center of the positive electrode current collector portion 20A in the stacking direction D3. This improves the foil-joining property of the positive electrode uncoated portion 22A when forming the positive electrode current collector portion 20A. As a result, such a thickness setting avoids foil-joining defects, such as a positive electrode uncoated portion 22A that is partially torn (foil breakage) when forming the positive electrode current collector portion 20A or layers of the positive electrode uncoated portion 22A that are not properly bonded together.

(2) When thickness T1 is in a range of 1.2 to 1.7 times thickness T2, the resultant force F3, which is the contraction stress difference between the first insulating layer 24A and the second insulating layer 24B, suitably acts on the positive electrode substrate 22. Also, the mechanical strength of the second insulating layer 24B will be sufficient.

(3) When thickness T1 is set in a range of 5.0 μm to 20.0 μm and thickness T2 is set in a range of 3.0 μm to 16.0 μm, the mechanical strength of the second insulating layer 24B is ensured. This also avoids decreases in the foil joining property of the positive electrode uncoated portion 22A caused by an increase in thickness T1 of the first insulating layer 24A.

(4) When the mass of the insulating layer binder is set to 30 mass % or less of the mass of the insulating layer 24, the insulating layer 24 avoids an excessive decrease in the mechanical strength. When the mass of the insulating layer binder is set to 10 mass % or greater of the mass of the insulating layer 24, the delamination strength is ensured between the insulating layer 24 and the positive electrode substrate 22. Further, the preferred resultant force F3, which is the contraction stress difference between the first insulating layer 24A and the second insulating layer 24B, is obtained.

(5) When width W1 of the first insulating layer 24A and width W1 of the second insulating layer 24B are set to 2.5 mm or greater, short circuiting is optimally restricted between the positive electrode uncoated portion 22A and the negative electrode plate 25. Further, the preferred resultant force F3, or the contraction stress difference, is obtained. When width W1 is set to 4.5 mm or less, width W2 of the positive electrode uncoated portion 22A in the widthwise direction D2 in will not become too small.

### Modified Examples

The above embodiment may be modified as described below.

Width W1 of the first insulating layer 24A and width W1 of the second insulating layer 24B may be greater than 4.5 mm as long as the foil joining property is not adversely affected. Further, width W1 of the first insulating layer 24A and width W1 of the second insulating layer 24B may be less than 2.5 mm as long as the contraction stress difference improves the foil joining property and short circuiting is restricted between the positive electrode uncoated portion 22A and the negative electrode plate 25.

The mass of the insulating layer binder with respect to the mass of the insulating layer 24 may be greater than 30 mass % as long as the mechanical strength of the insulating layer 24 is sufficiently ensured. Also, the mass of the insulating layer binder with respect to the mass of the insulating layer 24 may be less than 10 mass % as long as the contraction stress difference improves the foil joining property and the delamination strength is ensured between the insulating layer 24 and the positive electrode substrate 22.

Thickness T1 of the first insulating layer 24A may be less than 5.0 μm and thickness T2 of the second insulating layer 24B may be greater than 16.0 μm as long as the contraction stress difference improves the foil joining property. Thickness T1 of the first insulating layer 24A may be greater than 20.0 μm as long as the foil-joining property is not affected greatly by the increased thickness T1. Thickness T2 of the second insulating layer 24B may be less than 3.0 μm as long as the mechanical strength of the second insulating layer 24B is ensured.

Thickness T1 of the first insulating layer 24A may be less than 1.2 times thickness T2 of the second insulating layer 24B as long as the resultant force F3 suitably acts on the positive electrode substrate 22. Further, for example, if thickness T1 of the first insulating layer 24A is increased instead of excessively decreasing thickness T2 of the second insulating layer 24B, thickness T1 may be greater than the thickness T2 by 1.7 times or more. In this case, thickness T1 may only be set to avoid a situation in which the increase in thickness T1 lowers the foil joining property such that the positive electrode uncoated portion 22A becomes difficult to bend.

The first insulating layer 24A and the second insulating layer 24B may be formed from the same material or different materials. If the first insulating layer 24A and the second insulating layer 24B are formed from different materials, the materials may only be selected such that the first contraction stress F1 generated by the first insulating layer 24A becomes greater than the second contraction stress F2 generated by the second insulating layer 24B.

The electrode body 20 does not have to be a roll and may be a stack of rectangular positive electrode plates 21, rectangular negative electrode plates 25, and separators 28 accommodated in the case 11. For example, in such a stack-type electrode body 20, the first insulating layer 24A is arranged on a side of each positive electrode substrate 22 closer to the central layer of the stack in the stacking direction. The second insulating layer 24B is located opposite to the first insulating layer 24A with respect to the positive electrode substrate 22.

The lithium-ion rechargeable battery 10 may be another type of non-aqueous rechargeable battery, and may be, for example, a nickel-metal hydride battery.

The lithium-ion rechargeable battery 10 may be used in an automatic transporting vehicle, a special hauling vehicle, a battery electric vehicle, a hybrid electric vehicle, a computer, an electronic device, or any other system. For example, the lithium-ion rechargeable battery 10 may be used in a marine vessel, an aircraft, or any other type of movable body. The lithium-ion rechargeable battery 10 may also be used in a system that supplies electric power from a power plant via a substation to buildings and households.

### EXAMPLES

Example 1 and Comparative Examples 1 to 4 will now be described. Following examples are to illustrate the advantages of the above embodiment and not to limit the scope of the present disclosure. The manufacturing conditions and evaluation results of Example 1 and Comparative Examples 1 to 4 are shown in FIG. 8.

### Example 1

In Example 1, the electrode body 20 including the positive electrode plate 21 was prepared. The first insulating layer 24A had thickness T1 of 13 μm and the second insulating layer 24B had thickness T2 of 10 μm. In Example 1, thickness T1 of the first insulating layer 24A was 1.3 times thickness T2 of the second insulating layer 24B. In Example 1, the same insulating paste was used to form the first insulating layer 24A and the second insulating layer 24B. In Example 1, the mass ratio of the insulating layer binder to the entire first insulating layer 24A was 20 mass %, and the mass ratio of the insulating layer binder to the entire second insulating layer 24B was 20 mass %.

### Comparative Example 1

In Comparative Example 1, the electrode body 20 was prepared in the same manner as in Example 1 except in that the first insulating layer 24A and the second insulating layer 24B were not formed on the positive electrode plate 21.

### Comparative Example 2

In Comparative Example 2, the electrode body 20 was prepared in the same manner as in Example 1 except in that thickness T1 of the first insulating layer 24A was 2 μm and thickness T2 of the second insulating layer 24B was 2 μm.

### Comparative Example 3

In Comparative Example 3, the electrode body 20 was prepared in the same manner as in Example 1 except in that thickness T1 of the first insulating layer 24A was 10 μm and thickness T2 of the second insulating layer 24B was 10 μm.

### Comparative Example 4

In Comparative Example 4, the electrode body 20 was prepared in the same manner as in Example 1 except in that thickness T1 of the first insulating layer 24A was 20 μm and thickness T2 of the second insulating layer 24B was 20 μm.

Foreign Matter Resistance Evaluation

In each electrode body 20, foreign matter M having a predetermined size was disposed to be sandwiched between the first insulating layer 24A and the separator 28 at the side of the first surface 22B, and between the second insulating layer 24B and the separator 28 at the side of the second surface 22C. In Comparative Example 1, the foreign matter M was arranged where the first insulating layer 24A and the second insulating layer 24B were arranged in Example 1. Then, it was determined whether the foreign matter M penetrated the insulating layer 24 and reached the positive electrode substrate 22 on each of the first surface 22B and the second surface 22C. If the foreign matter M did not penetrate the insulating layer 24 and did not reach the positive electrode substrate 22, it was evaluated as satisfactory (“o”, circle). If the foreign matter M penetrated the insulating layer 24 and came into contact with the positive electrode substrate 22, it was evaluated as poor (“x”).

Evaluation of Foil-Joining Property

In Example 1 and Comparative Examples 1 to 4, it was determined whether a foil-joining defect was observed in the positive electrode current collector portion 20A of each electrode body 20. The electrode bodies 20 subjected to the foil joining property evaluation differed from those used for the foreign matter resistance evaluations.

Evaluation Results

As shown in FIG. 8, in the foreign matter resistance evaluations, in Example 1 and Comparative Examples 3 and 4, the foreign matter M did not penetrate the first insulating layer 24A or the second insulating layer 24B and did not reach the positive electrode substrate 22. Comparative Example 1 was evaluated as poor because the electrode body 20 did not include any of the first insulating layer 24A and the second insulating layer 24B. In Comparative Example 2, the foreign matter M penetrated the first insulating layer 24A and reached the positive electrode substrate 22. In Comparative Example 2, the foreign matter M also penetrated the second insulating layer 24B and reached the positive electrode substrate 22. It can be determined that thickness T1 and thickness T2 in Comparative Example 2 were both too small and thus the first insulating layer 24A and the second insulating layer 24B had insufficient mechanical strengths.

Regarding the foil-joining property evaluation, in Example 1 and Comparative Examples 1 and 2, no foil joining defect was observed in the positive electrode current collector portion 20A and the bonding state was satisfactory. On the other hand, in Comparative Examples 3 and 4, defective foil-joining, such as tearing of the positive electrode uncoated portion 22A, was observed. In particular, Comparative Example 4 included more foil-joining defects than Comparative Example 3. This indicates that the positive electrode substrate 22 became difficult to bend at a position where the insulating layer 24 was arranged because of the increase in the thickness of the insulating layer 24. Accordingly, a large force was applied to the positive electrode uncoated portion 22A and tore the positive electrode uncoated portion 22A when joining the positive electrode uncoated portion 22A.

As described above, it was confirmed that even when the thickness of the insulating layer 24 was increased so as to increase the mechanical strength of the insulating layer 24, the foil-joining property of the positive electrode current collector portion 20A was improved when forming the positive electrode current collector portion 20A if thickness T1 of the first insulating layer 24A was set to be greater than thickness T2 of the second insulating layer 24B.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A non-aqueous rechargeable battery, comprising:
an electrode body in which a positive electrode plate and a negative electrode plate are stacked in a stacking direction with a separator arranged in between, wherein
the positive electrode plate includes
a foil-like positive electrode substrate, and
a positive electrode mixture layer and an insulating layer arranged on each of two opposite surfaces of the positive electrode substrate;
the positive electrode substrate includes a positive electrode uncoated portion free from the positive electrode mixture layer and the insulating layer;
the electrode body includes a positive electrode current collector portion in which layers of the positive electrode uncoated portion are stacked in the stacking direction;
the insulating layer is located between the positive electrode mixture layer and the positive electrode uncoated portion;
the insulating layer on a first surface of the positive electrode substrate defines a first insulating layer, the first surface facing a center of the positive electrode current collector portion in the stacking direction;
the insulating layer on a second surface of the positive electrode substrate opposite to the first surface defines a second insulating layer; and
the first insulating layer has a thickness that is greater than that of the second insulating layer.

2. The non-aqueous rechargeable battery according to claim 1, wherein the thickness of the first insulating layer is in a range of 1.2 to 1.7 times the thickness of the second insulating layer.

3. The non-aqueous rechargeable battery according to claim 2, wherein
the thickness of the first insulating layer is in a range of 5.0 μm to 20.0 μm, and
the thickness of the second insulating layer is in a range of 3.0 μm to 16.0 μm.

4. The non-aqueous rechargeable battery according to claim 1, wherein
the insulating layer includes a binder, and
a mass ratio of the binder to a mass of the insulating layer is in a range of 10 mass % to 30 mass %.

5. The non-aqueous rechargeable battery according to claim 1, wherein the first insulating layer and the second insulating layer each have a width in a range of 2.5 mm to 4.5 mm.
